(19) United States
(12) Patent Application Publication
(10) Pub. No.: US 2021/0095776 A1
(43) Pub. Date: Apr. 1, 2021

(54) VALVE BODY

(71) Applicant: VIS, LLC, Travelers Rest, SC (US)

(72) Inventor: Billy R. Lee, JR., Moore, SC (US)

(73) Assignee: VIS. LLC, Travelers Rest, SC (US)

(21) Appl. No.: 16/587,484

(22) Filed: Sep. 30, 2019

(51) Int. Cl. F16K 27/02; B25D 9/18

(52) U.S. Cl. CPC F16K 27/0281; B25D 9/18

(57) ABSTRACT

A bi-directional valve body for a pneumatic hammer is provided which has non-circular air intake and air exhaust ports within lateral walls of the valve body and which provides for a smaller mass and volume while increasing the efficiency of air flow through the valve body. A length of the valve body is greater than a width, and allows for less resistance of air flow into the lateral walls defined within the respective valve body halves.

### FIELD OF THE INVENTION

The present invention relates generally to the field of fluid driven power hand tools, and, more particularly, to a pneumatic hammer having a new air valve therein which enables more effective airflow through the tool.

### BACKGROUND OF THE INVENTION

Air hammers are power hand tools which have been commonly used in the automotive assembly and repair fields.

One type of pneumatic hammer which may be used with the present invention is usually a pistol-grip style hand tool that is equipped with, a free-floating steel piston housed in the rear of a steel barrel. High pressure air is forced through the air valve of the hammer and causes the piston to travel outwardly from the rear end of the barrel to the open front end thereof, thus constituting one blow of the hammer. A work tool which has been inserted into the open end of the barrel is impacted by the piston and will impact an object with its face which is appropriately shaped in accordance with the work to be accomplished. Typically, such impact devices impact an object in the range of about 1,000 to about 3,000 blows per minute.

One known style of bi-directional air valves in pneumatic hammers can be seen in reference to U.S. Pat. No. 5,417,294 and which is incorporated herein by reference.

### SUMMARY OF THE INVENTION

It is one aspect of at least one of the present embodiments to provide for a valve body comprising;

a first body portion having a front surface and a back surface;

a second body portion having a front surface and a back surface, the first body portion having, a thickness greater than a thickness of the second body portion;

a valve body disc member positioned between the second body portion back surface and the front body portion back surface, the first body portion further defining a receiving area within the back surface for receiving therein a valve body disc, the each body portion further having a length greater than a width;

the first body portion further defining at least two ports each of the two ports traversing respective portions lateral walls, the at least two ports defined within the lateral walls being in further fluid communication with one or more of a plurality of apertures defined within the receiving area of the first body portion;

the second body portion defining a at least one port connecting opposite surfaces of an, edge wall, the at least one port being in fluid communication with a plurality of apertures positioned within a recess defined by an interior wall and opposite the valve body disc;

wherein, the at least two ports of the first body portion, the at least one ports on the second curved edge wall of the second body portion, the first inlet port, the second inlet port, the plurality of apertures within the first body portion receiving area, and the plurality of apertures within the interior wall recess of the second body portion, allow pressurizing fluid to flow through the valve chamber between the closed rearward end of the hammer body portion and the piston to direct the flow of fluid through the valve body, alternately driving a piston in a forward and rearward position.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is an exploded view of a prior art pneumatic hammer having a valve body.

FIG. 2 illustrates a valve body half that may be used in a pneumatic hammer.

FIG. 3 illustrates an alternative embodiment of a valve body half that may be used in a pneumatic hammer.

FIG. 4 is an exploded view of a valve further illustrating the positioning and arrangement of the component valve body halves seen in FIGS. 2 and 3.

FIG. 5 is a plan view of a first body portion of a valve body illustrating a surface that receives a valve disc.

FIG. 6 is a plan view of a second body portion of a valve body illustrating a surface that receives a valve disc.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as, come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied, in the exemplary constructions.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

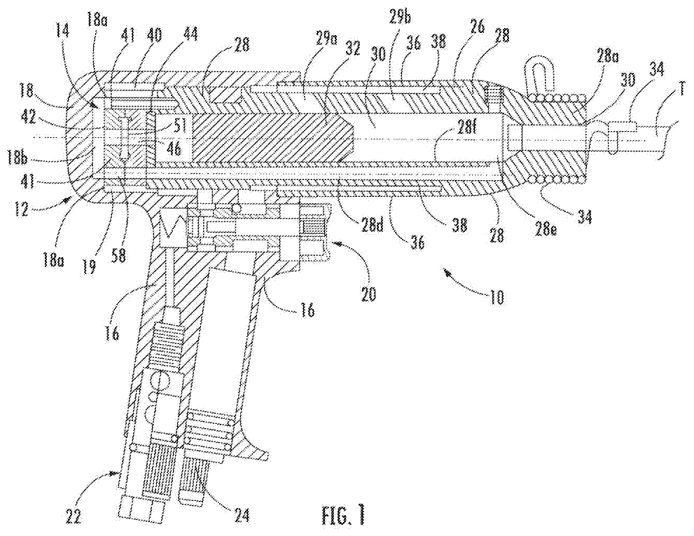

With reference to the drawings, and particularly with regard to FIG. 1, 10 generally designates a pneumatic hammer having a main body portion 12 and a valve 500 housed therein, which valve is constructed in accordance with and embodies the present invention. With the exception of air valve 500, pneumatic hammer 10 can take other overall forms, besides the usual pistol-grip style shown herein, and still be suitable for use with the new air valve.

As the pneumatic hammer per se is of a conventional style, an overly detailed discussion thereof will be avoided. Some parts of the hammer, although shown, will not be called out because they do not pertain in any particularly significant manner specifically to the new air valve, and their structure can vary without altering the scope of the invention.

Main body portion 12 of hammer 10 includes a handle or grip 16 which is suitably penetrated longitudinally for passage in and out of pressurized air from a source thereof (not shown). Handle 16 depends from a butt portion 18 which is formed with a generally cylindrical forward opening for housing air valve 500, which is ultimately in communication with the inward and outward channels of air flow provided through handle 16.

FIG. 1 shows a spring-biased trigger assembly, generally designated 20, which is disposed generally transversely within handle 16 and constructed in known manner so that operation thereof initiates inflow from the source of pressurized air via a regulator assembly, for example, such as that generally designated 22, which is coupled to the base of handle 16.

As shown in FIG. 1, trigger assembly 20 is in the off or closed position, Upon depressing of the trigger pressurized air can pass through assembly 20 for operation of hammer 10, as will be described further hereafter.

Air outflow from hammer 10 is ultimately and preferably via an air deflector 24 which is ordinarily connected at the base of handle 16 adjacent to regulator assembly 22. Appropriately sized seals and O-rings, such as, for example, those indicated at 26, are disposed in the usual manner within the above assemblies and throughout pneumatic hammer 10, to ensure an air-tight fit of the parts of hammer 10 as required for proper functioning thereof.

With reference to FIG. 1, pneumatic hammer 10 has an elongated cylindrical barrel 28 which is preferably securely coupled, for example by threaded connection, to the butt portion 18 of main body portion of hammer 10. Barrel 28 is formed with a longitudinal bore 30 for sliding travel therein of a piston 32. At the forward end of barrel 28 bore 30 opens outwardly and provides a site for connection of a known striking or cutting tool T, such as a chisel. A retainer such as that indicated at 34 is preferably provided at the forward extreme of barrel 28 to ensure against inadvertent displacement of the chisel or other selected cutting or striking tool T.

A narrow, longitudinal channel 28d is provided within barrel 28 and is desirably disposed substantially adjacent to and above trigger assembly 20. At the forward end of channel 28d there is an aperture 28e which permits passage of air through a wall 28f which separates channel 28d and bore 30 so that air can pass between channel 28d and barrel bore 30 for purposes to be described later.

Coaxially outward from barrel 28 there is mounted a cylindrical barrel cover or exhaust duct 36, the rearward end of which is journaled within the forwardly facing opening of butt portion 18 of main body 12. The forward end of barrel cover 36 is sealed securely to and spaced outward from the barrel by O-rings which are seated against annular shoulders formed on the exterior side wall spaced rearwardly of the forward end 28a of barrel 28.

In this manner, or by other known constructions, an exhaust air space is formed around barrel 28 inside of and coaxial with exhaust duct 38, Air space is in communication with bore 30 via exhaust apertures or ports 29a, 29b which are formed through the barrel for expulsion of air outwardly therefrom to the exhaust air space region 38 and ultimately through exhaust deflector 24 upon firing of hammer 10 and striking and recoil of piston 32.

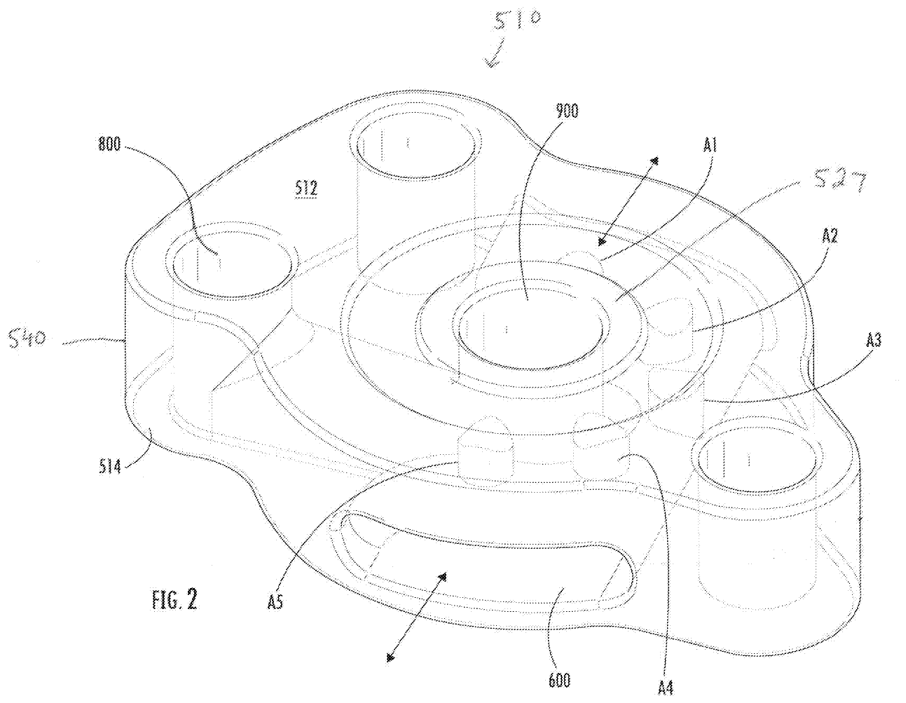

FIGS. 2-4 illustrate a preferred embodiment of an air valve 500 that may be disposed in coaxial alignment with and is adjacent to the rearward end of barrel 28, inside of the closed butt end 18 of hammer 10 seen in FIG. 1. Generally, air valve 500 consists of paired, similar shaped valve body halves of a first portion 520 and a second portion 510 which loosely sandwich a valve disc 530 therebetween.

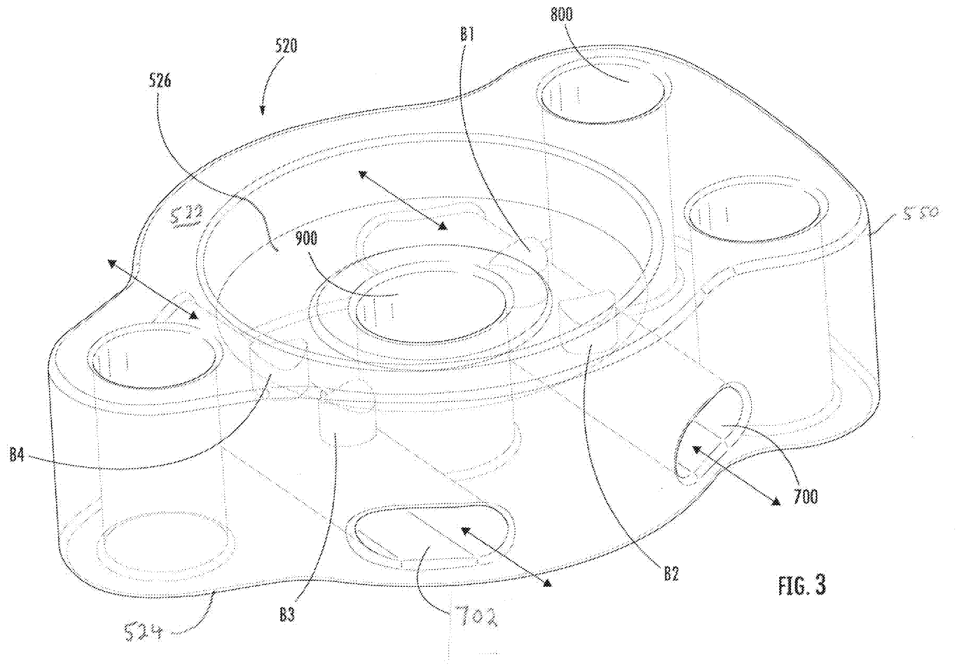

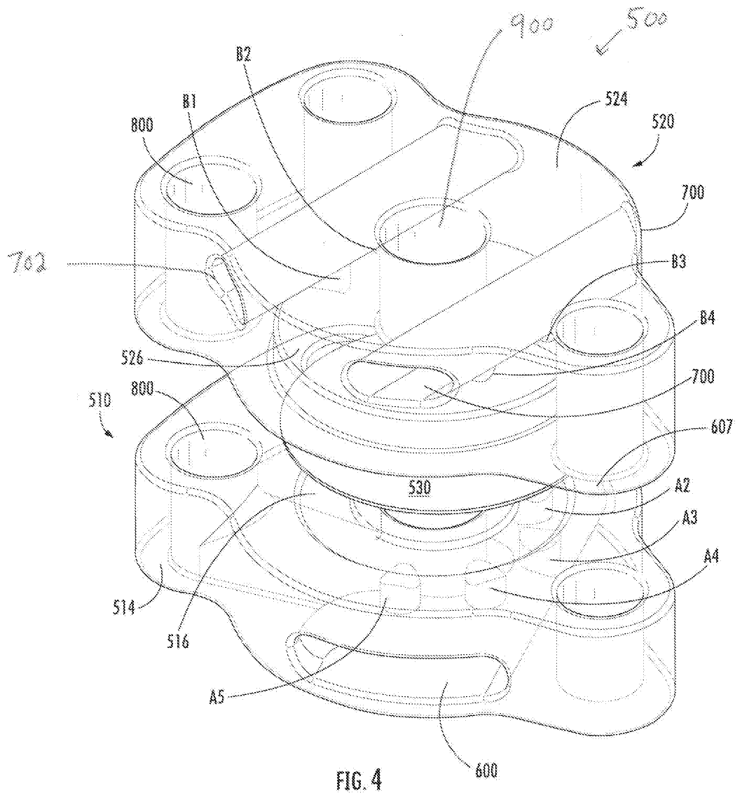

As seen in FIGS. 2-4 valve body 500 is provided having a first body portion 520 (FIG. 3) having a front face surface 522 and a back surface 624; a second body portion 510 (FIG. 2) having a front face surface 512 and a back surface 514, the first body portion 520 having a thickness greater than a thickness of the second body portion 510. A valve body disc member 530 is positioned between the second body portion 510 BY surface 512 and the first body portion surface 522, the first body portion 520 defining a respective receiving area 526 and 527 within the surface 522 for receiving therein a valve body disc 530 (FIG. 4), each valve body portion 510 and 520 further having a length greater than a width. As seen in FIG. 3, the surface surrounding aperture 900 supports disk 530, below surface 522, and within pocket 526.

The first body portion may further define at least one port 700 connecting a first curved lateral wall portion and an opposite second curved lateral wall, the port 700 connecting the first and second curved lateral walls being in further fluid communication with a plurality of apertures B1-B4 defined within the disc receiving area 526 of the first body portion 520.

The second body portion 510 defines a port 600 along a first edge wall and is in communication with an opening defined within an opposite second edge wall, the port 600 being in fluid communication with the plurality of apertures A1-A5 positioned with a recess of 527 defined within the surface 512 and opposite the valve body disc 530 seen in FIG. 4,

In operation, the at least one port 700 on the first curved edge wall of the first body portion 520, the first port 600, the plurality of apertures B1-B4 within the receiving area of 526 and 527, and the plurality of apertures A1-A5 within the interior wall recess of the second body portion 510, allow pressurizing fluid to flow through the valve chamber between the closed rearward end of the hammer body portion and the piston to direct the flow of fluid through the valve body, alternately driving a piston in a forward and rearward position.

The face 522 of portion 520 which defines the recessed area 526 allows the disc 530 to be received in a manner that positions the disc below a surface of the plane of the face 522. As the air pressure varies with respect to the valve body portions 510 and 520, the disc 530 will be displaced between the respective faces 512 and 522 of the valve body halves 510 and 520. In this manner, the volume of air which flows through apertures A1-A5 and B1-B4 will vary and thereby regulate the air flow through side wall opening 600 of second body portion 510 along with the air flow through port defined within the first body portion 520.

Air will also flow through the center port 900 of the respective body valve halves 510 and 520. As the valve disc 530 moves relative to air pressure variance, it allows air flow and pressure to building through ports A1-A5 of valve body half 510. The ports A1-A5 are connected to the center port of valve body portion 510 and the center port is further connected to port 800 which allows for a pressure increase to the forward end of barrel bore 30, via conduit 28D, pushing piston 32 in a rearward direction. Subsequently, as the valve disc 530 moves closer to the center port in valve body portion 510, air flow and pressure starts to build through ports B1-B4 of valve body half 520 and into its center port 900 and then begins to allow pressure to build within the barrel bore 30 pushing piston 32 forward inside of bore 30. This process repeats in cycles as air pressure varies between the two valve body halves.

More specifically, each valve body portion 510 and 520 has a substantially planar face surface 512 and 522, respectively, and the substantially planar back surfaces 514 and 524 respectively. The face and back surfaces are preferably circumferentially limited by respective side walls 540 and 550 which extends between and connects the faces 512 and 522 and back sides 514 and 524 surfaces of the respective valve body portion. As shown in FIGS. 2-4, valve body portion 510 is disposed coaxially, rearwardly of valve body portion 520, which is seated against an annular shoulder 18a (FIG. 1) formed within the closed butt end 18 of hammer body 12. With valve body 500 so positioned, an annular space 19 seen in FIG. 1 extends around valve 500 from the outer, circular side wall thereof to the interior surrounding wall of butt portion 18 of main body 12, forwardly of ledge 18a.

For normal operation of valve 500, the two valve body face surfaces 512, 522 are positioned inwardly, facing and touching, flush against one another, with surface 514 directed rearwardly and surface 524 directed forwardly with respect to the direction of hammer main body portion 12. Valve body portions 510 and 520 each have a preferred, non-circular shape which may vary somewhat as may be appropriate for the particular application, such as for use of valve 500 within a pneumatic hammer having a different internal size or shape of main body butt portion 18. FIGS. 2 through 3 illustrate in detail the structure of valve body portions 510 and 520 and show openings which permits passage therethrough of pressurized air.

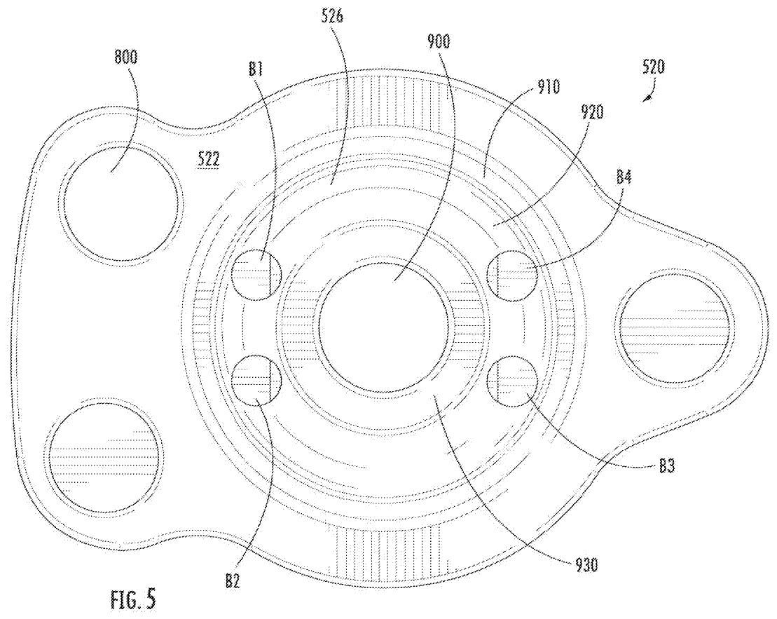

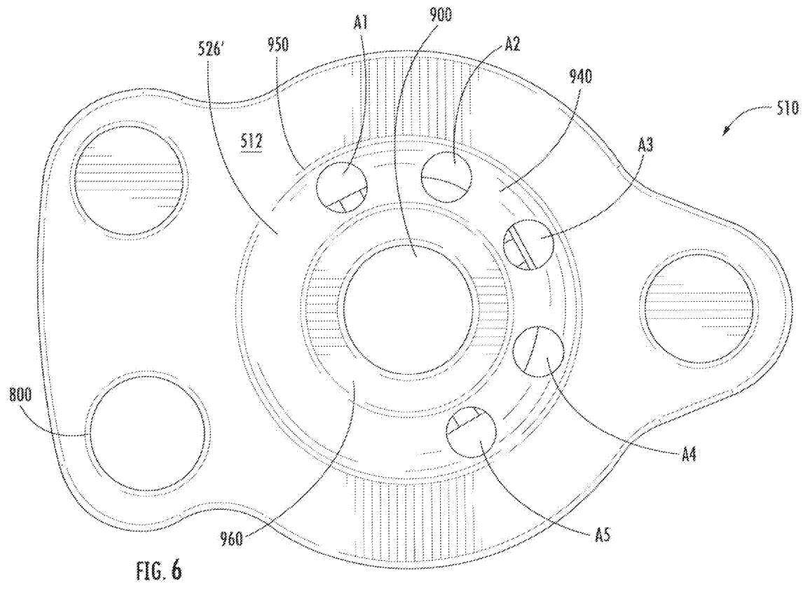

FIGS. 5 and 6 illustrate face surfaces 512 and 522 which are normally flush and, as best seen in reference to FIG. 4, are separated by a disc 530. As seen in FIG. 5, valve body portion 520 defines a circular recessed area 526. The recessed area 526 further defines a floor region 920 through which apertures B1-B4 are defined. The floor area in which the apertures B1-B5 are defined is curved between the upper edge of outer lip 910, which is below a surface of wall 522, and an upper edge of cylinder 930 defined in part by an interior wall surface of conduit 900. In operation, the valve disc 530 will nest within the recess 526 and will engage the upper surface of the cylinder 930. When the disc 530 is supported by cylinder 930, the disc is below a plane defined by wall surface 522.

As seen in FIG. 6, valve body portion 510 has a recessed area 527 and also has a curved floor surface 940 defined between the cylinder 960 and the outer circumferential edge wall 950. Apertures A1-A5 are defined within the floor surface 940. The upper surface of cylinder 960 is co-planer with the surface 512. The diameter of wall 950 is less than the diameter of outer lip 910 seen in FIG. 5. In operation, the disc 530 diameter is greater than the diameter of edge wall 950 such that the disc 530, when engaged, touches the wall surface 512 and the upper surface of cylinder 900 during reciprocating movement.

The curved floor surfaces of respective floors 940 and 920 allow for air flow around the defined apertures A1-A5 and B1-B4 with less resistance. The opposing cylinder wall upper surface of 960 and 930 will always have a gap therebetween that will facilitate the movement of air within the recess 526.

In reference to FIGS. 2-4, the flow of pressurized air is illustrated through the valve body portion 520. As seen in reference to FIG. 4, an exploded view of the valve body 500 having a disc 530 therebetween portions 510 and 520 is illustrated.

In operation, an initial air flow direction passes through the lateral side walls of the valve body comprising air passages 600 and 602. As a pressure differential is established within the chamber of the air hammer, air flow and pressure differences will occur along, apertures A1-A5 (FIG. 2) and B1-B4 (FIG. 3). The pressure changes will displace disc 530 which controls air flow from side wall openings 600 and 602 of valve body portion 510 and airflow along openings 700 and 702 of valve body portion 520.

As further seen in reference to FIG. 3, port 800 allows bi-lateral pressure and air flow from surface 522 to surface 524 a port defined along a barrel of the air hammer. As is known in the art, the air/pressure flow will actuate the piston in alternative directions and create the reciprocal movement of disc 530 which further controls air flow through valve 500.

The directional arrows seen in FIGS. 2-4 indicate the bi-directional air flow within and through the valve body 500 and respective valve body portion 520 and portion 510.

The valve body described herein offers several improvements to existing valve body constructions. One, the compact mass allows for a greater volume of air to be present within the air chamber of the air hammer. Additionally, the ports defined on the curved walls of body portions 510 and 520 the inlet and the outlet are non-circular and have a surface area of the respective openings that is greater than could be provided by a circular aperture defined within the edge walls. Accordingly, there is an ability to have a greater volume of air flow moving through the valve body.

Additionally, the ports are positioned such that there is a greater gap or space between the curved edge walls and the adjacent chamber walls of the air hammer. This arrangement provides less resistance to air flow in and out of the ports, thereby increasing the efficiency of operation with respect to the amount of air supplied to, the tool.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, either in whole, or in part. Therefore, the spirit and scope of the appended claims should not be limited to the description of the preferred versions contained therein.

That which is claimed:

1. A valve body comprising:
a first body portion having a front surface and a back surface;
a second body portion having a front surface and a back surface, the first body portion having a thickness greater than a thickness of the second body portion;
a valve body disc member positioned between the second body portion back surface and the front body portion back surface, the first body portion further defining a receiving area within the back surface for receiving therein a valve body disc, each body portion further having a length greater than a width;
the first body portion further defining at least two ports each of the two ports traversing respective portions lateral walls, the at least two ports defined within the lateral walls being in further fluid communication with one or more of a plurality of apertures defined within the receiving, area of the first body portion;
the second body portion defining a at least one port connecting opposite surfaces of an edge wall, the at least one port being in fluid communication with a plurality of apertures positioned within a recess defined by an interior wall and opposite the valve body disc;
wherein, the at least two ports of the first body portion, the at least one ports on the second curved edge wall of the second body portion, the first inlet port, the second inlet port, the plurality of apertures within the first body portion receiving area, and the plurality of apertures within the interior wall recess of the second body portion, allow pressurizing fluid to flow through the valve chamber between the closed rearward end of the hammer body portion and the piston to direct the flow of fluid through the valve body, alternately driving a piston in a forward and rearward position.
